(19) United States
(12) Patent Application Publication
(10) Pub. No.: US 2008/0018823 A1
(43) Pub. Date: Jan. 24, 2008

(54) System for displaying images including liquid crystal display and fixing method for fabricating the same

(75) Inventor: Wen-Chang Wang, Jhunan Township (TW)

Correspondence Address: LIU & LIU, 444 S. FLOWER STREET, SUITE 1750, LOS ANGELES, CA, 90071, US

(73) Assignee: TPO Displays Corp.

(21) Appl. No.: 11/490,653

(22) Filed: Jul. 21, 2006

(51) Int. Cl. G02F 1/1333

(52) U.S. Cl. 349/58

(57) ABSTRACT

A liquid crystal display comprises a frame, a backlight module, a panel module and an ultraviolet glue. The backlight module is installed in the frame. The panel module is located on the backlight module. The ultraviolet glue is installed between the panel module and the frame for fixing the panel module and the frame. Steps of a fixing method for a liquid crystal display comprise: placing a backlight module in a frame; placing a panel module on the backlight module; placing an ultraviolet glue between the panel module and the frame.

### BACKGROUND

The present invention relates to a system for displaying images including a liquid crystal display and a fixing method for fabricating the same.

Referring to FIG. 1, a conventional liquid crystal display 10 comprises a frame 13, a panel module 11, a rim tape 141 and a backlight module 12. The backlight module 12 is installed on the bottom of the frame 13. The panel module 11 is installed on the backlight module 12. The rim tape 141 is installed between the backlight module 12, the panel module 11 and the frame 13 for fixing the panel module 11 on the backlight module 12 and the frame 13. The thickness of the rim tape 141 is about 0.05 mm to 0.15 mm. Thus, the rim tape 141 under the panel module 11 increases the thickness of the liquid crystal display 10. Moreover, referring to FIG. 2, an uncut tape 14 is divided into the rim tape 141 and a remainder 142. The center of the rim tape 141 comprises a light-permeable hollow area 143. Because the remainder 142 cut from the uncut tape 14 is useless, the fixing method for the conventional liquid crystal display 10 is expensive.

Thus it can be seen that the fixing method for the conventional liquid crystal display 10 increases display thickness and cost.

### SUMMARY

A detailed description is given in the following embodiments with reference to the accompanying drawings.

A system for displaying images comprises a liquid crystal display, comprising a frame, a backlight module, a panel module and an ultraviolet glue. The backlight module is installed in the frame. The panel module is located on the backlight module. The ultraviolet glue is installed between the panel module and the frame for fixing the panel module to the frame.

The steps of a fixing method of fabricating a system for displaying images, wherein the system comprising a liquid crystal display, comprise: placing a backlight module in a frame; placing a panel module on the backlight module; placing an ultraviolet glue between the panel module and the frame and solidifying the ultraviolet glue.

### BRIEF DESCRIPTION OF THE DRAWINGS

The present invention can be more fully understood by reading the subsequent detailed description and examples with references made to the accompanying drawings, wherein:

FIG. 1 is a schematic view showing a conventional liquid crystal display;

FIG. 2 is a schematic view showing an uncut tape divided into a rim tape and a remainder;

FIG. 3 is a schematic view showing an embodiment of a liquid crystal display of the invention;

FIG. 4 is a schematic view showing another embodiment of a liquid crystal display of the invention;

FIG. 5 shows the steps of a fixing method for a liquid crystal display of the invention; and

FIG. 6 schematically shows a system for displaying images.

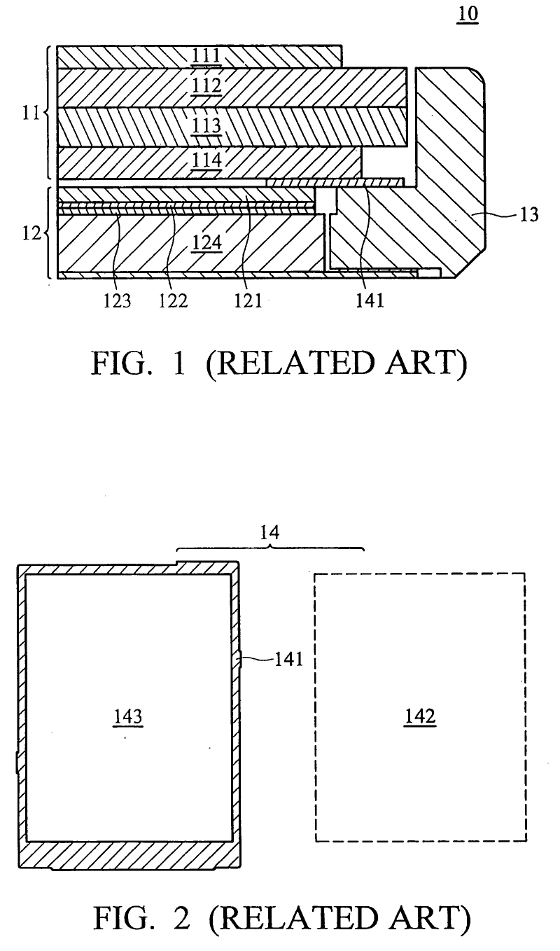

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

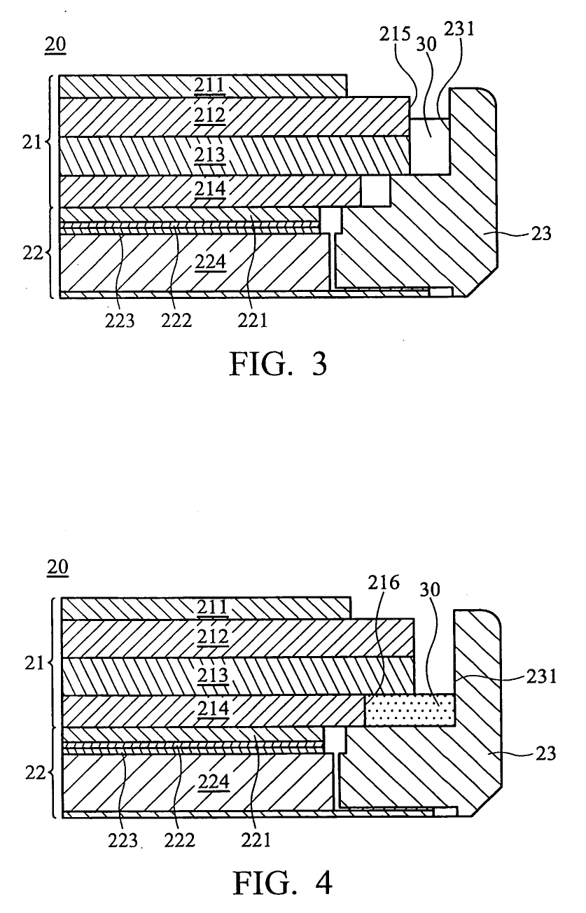

Referring to FIG. 3, a liquid crystal display 20 comprises a panel module 21, a backlight module 22, a frame 23 and an ultraviolet glue 30. The panel module 21 is located on the backlight module 22. The backlight module 22 is installed on the bottom of the frame 23. The frame 23 comprises an inner side surface 231. The ultraviolet glue 30 is applied between the panel module 21 and the frame 23 for fixing the panel module 21 and the frame 23. In this embodiment, the panel module 21 comprises a first optical film 211, a color filter substrate 212, a TFT array substrate 213 and a second optical film 214 stacked in order. The backlight module 22 comprises a first diffusion film 221, a prism film 222, a second diffusion film 223 and a light guide plate 224 stacked in order. Moreover, in this embodiment, the ultraviolet glue 30 is installed between the inner side surface 231 of the frame 23 and a side surface 215 of the color filter substrate 212 and the TFT array substrate 213. Note that the ultraviolet glue 30 may be black via addition to a toner or a pigment for decreasing light leakage.

The embodiment of a liquid crystal display 20 shown in FIG. 4 comprises a panel module 21, a backlight module 22, a frame 23 and an ultraviolet glue 30. The panel module 21 is located on the backlight module 22. The backlight module 22 is installed on the bottom of the frame 23. The frame 23 comprises an inner side surface 231. The ultraviolet glue 30 is installed between the panel module 21 and the frame 23 for fixing the panel module 21 and the frame 23. In this embodiment, the panel module 21 comprises a first optical film 211, a color filter substrate 212, a TFT array substrate 213 and a second optical film 214 stacked in order. The backlight module 22 comprises a first diffusion film 221, a prism film 222, a second diffusion film 223 and a light guide plate 224 stacked in order. Note that in this embodiment, the ultraviolet glue 30 is applied between the inner side surface 231 of the frame 23 and a side surface 216 of the second optical film 214. Note that the ultraviolet glue 30 may be black via addition to a toner or a pigment for decreasing light leakage.

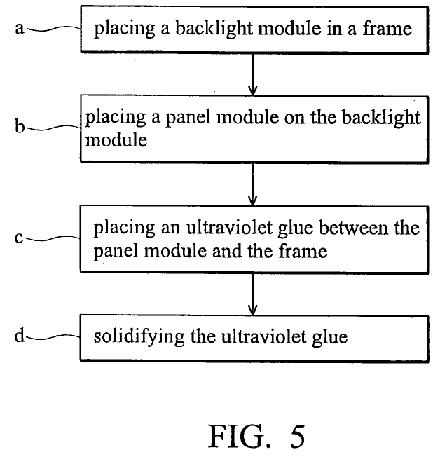

FIG. 5 shows the steps of a fixing method for a liquid crystal display, comprising: a. placing a backlight module in a frame; b. placing a panel module on the backlight module; c. placing an ultraviolet glue between the panel module and the frame and d. solidifying the ultraviolet glue. Referring to FIG. 3, the backlight module 22 is placed in the bottom of the frame 23 first. Then the panel module 21 is placed on the backlight module 22. The ultraviolet glue 231 is placed between the panel module 21 and the frame 23. Note that the ultraviolet glue 231 is in the liquid state during placement between the panel module and the frame. Finally, the ultraviolet glue 30 is solidified via an ultraviolet light 31.

The ultraviolet glue 30 connects to the panel module 21 and the frame 23 laterally, thus, the invention can reduce the thickness of the conventional liquid crystal display 20. Moreover, waste of the tape remainder 142 is eliminated and the ultraviolet glue 30 of the invention for fixing the panel module 21 to the frame 23 reduces the cost.

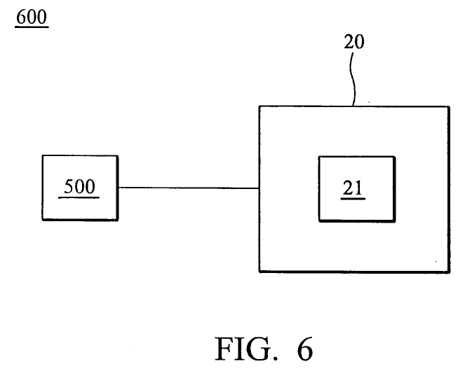

FIG. 6 schematically shows a system for displaying images which, in this case, is implemented as a liquid crystal display 20 or an electronic device 600. The liquid crystal display 20 can form a portion of a variety of electronic devices (in this case, electronic device 600). The electronic device 600 comprises the liquid crystal display 20 and an input unit 500. The liquid crystal display 20 comprises the panel module 21. The input unit 500 is coupled to the liquid crystal display 20 and operative to provide input to the liquid crystal display 20 such that the liquid crystal display 20 displays images. The electronic device 600 can be a mobile phone, digital camera, PDA (personal data assistant), notebook computer, desktop computer, television, car display, or portable DVD player, for example.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images, comprising:
a liquid crystal display, comprising:
a frame;
a backlight module, installed in the frame;
a panel module, located on the backlight module; and
an ultraviolet glue between the panel module and the frame for fixing the panel module and the frame.

2. The system as claimed in claim 1, wherein the frame comprises an inner side surface and the panel module comprises a side surface, the ultraviolet glue connects the inner side surface of the frame to the side surface of the panel module.

3. The system as claimed in claim 1, further comprising an electronic device, wherein the electronic device comprises:
the liquid crystal display; and
an input unit coupled to the liquid crystal display and operative to provide input to the liquid crystal display such that the liquid crystal display displays images.

4. A fixing method of fabricating a system for displaying images, wherein the system comprising a liquid crystal display, the step comprising:
placing a backlight module in a frame;
placing a panel module on the backlight module;
placing an ultraviolet glue between the panel module and the frame; and
solidifying the ultraviolet glue.

5. The fixing method as claimed in claim 4, wherein an ultraviolet light solidifies the ultraviolet glue in the step of solidifying the ultraviolet glue.

6. The fixing method as claimed in claim 4, wherein in the step of placing an ultraviolet glue between the panel module and the frame, the ultraviolet glue connects an inner side surface of the frame to a side surface of the panel module.
